(19) United States
(12) Patent Application Publication
(10) Pub. No.: US 2025/0282213 A1
(43) Pub. Date: Sep. 11, 2025

(54) REINFORCED STORAGE TANK FOR A VEHICLE

(71) Applicant: PLASTIC OMNIUM ADVANCED INNOVATION AND RESEARCH, Bruxelles (BE)

(72) Inventors: Jean-Christophe LEMAIRE, Bruxelles (BE); Jules-Joseph VAN SCHAFTINGEN, Bruxelles (BE)

(73) Assignee: PLASTIC OMNIUM ADVANCED INNOVATION AND RESEARCH, Bruxelles (BE)

(21) Appl. No.: 18/861,432

(22) PCT Filed: May 5, 2023
(86) PCT No.: PCT/EP2023/061922

§ 371 Date: Oct. 29, 2024

(30) Foreign Application Priority Data
May 6, 2022 (LU) LU502042

(51) Int. Cl. B60K 15/067; B60K 15/03

(52) U.S. Cl. CPC B60K 15/067; B60K 15/03177; B60K 2015/03328; B60K 2015/03493

(57) ABSTRACT

A storage tank for a vehicle includes: a wall delimiting a storage volume, and including first and second wall portions, the first wall portion has a first depression formed therein extending towards the second wall portion, the first depression includes a first opening, a first bottom wall and a first peripheral side wall connecting the first bottom wall to a first flange of the first opening, the first bottom wall is coupled to the second wall portion in a coupling area having a hole through which passes a connecting rod of a clamping device, the clamping device includes first and second clamping portions connected to each other by the connecting rod. The first clamping portion is disposed on an outer face of the first peripheral side wall and the second clamping portion is disposed on an outer face of the second wall portion.

The invention relates to a storage tank for a vehicle. More precisely, the invention relates to a reinforced storage tank for a vehicle and a vehicle comprising such a storage tank.

Storage tanks for containing liquid and gas such as fuel and fuel vapor may experience increased pressure during certain operating conditions. The increased pressure may be caused by the expansion of fuel vapor due to an increase in temperature in a sealed fuel tank. The time a fuel tank is sealed can be longer in hybrid vehicles using both an electric motor and an internal combustion engine for providing power compared to vehicles relying solely on internal combustion engines for providing power. The longer time may be due, in part, to the irregular use of the internal combustion engine in the hybrid vehicle. Consequently, the relative pressure in a fuel tank of a hybrid vehicle may reach levels that are many times greater than those experienced in systems where the fuel tank is routinely purged to the engine whenever necessary. In some circumstances the relative pressure in a fuel tank of a hybrid vehicle may be 15-20 times greater than the maximum values experienced by a fuel tank in a vehicle relying solely on an internal combustion engine for providing power to the vehicle.

Therefore, a fuel tank for a hybrid vehicle needs to be reinforced compared to a fuel tank for a vehicle relying solely on an internal combustion engine. This is particularly true for fuel tanks made of plastic such as high-density polyethylene (HDPE) for example.

Solutions have been proposed in the prior art to enhance the mechanical strength of a plastic fuel tank.

A well-known technique to reinforce a plastic fuel tank is to use a so-called kiss point or tack-off point as described in document US 2002/0100759 A1. The principle of this technique is to locally connect the upper and lower walls of the fuel tank through weld points/areas. The main drawback of this technique is that since the kiss points are of small size in order to limit the loss of useful volume of the fuel tank, they lead to the concentration of mechanical stress at said kiss points when the pressure in the fuel tank increases, which may lead to cracks or other damages over time.

Document US 2007/0228050 describes a fuel tank with an upper recess in the upper wall and a lower recess in the lower wall that are abutted against each other to form a joint. This document proposes to seal at least one recess with a cover in order to contain a fuel leakage from a cracked recess.

Document US 2018/037105 A1 proposes to reinforce a kiss point of a fuel tank with an external reinforcement. To this end, a mechanical fastener extending through the kiss point is provided. Although the mechanical fastener acts to decrease mechanical stress at the kiss point when the pressure in the fuel tank increases, it cannot prevent the kiss point from cracks or other damages over time since the kiss point must remain of small size in order to limit the loss of useful volume of the fuel tank. To address this problem, washer plates are provided between the mechanical fastener and external surfaces of the kiss point. Although the washer plates provide greater load dispersion at the kiss point when the pressure in the fuel tank increases, they still cannot prevent the kiss point from cracks or other damages over time since the kiss point must remain of small size in order to limit the loss of useful volume of the fuel tank.

The present invention addresses this problem by providing an externally reinforced storage tank that prevents the kiss point from cracks or other damages over time, irrespective of the size of the kiss point.

To this end, the present invention concerns a storage tank for a vehicle comprising a wall delimiting a storage volume for containing a liquid and gas, the wall comprises a first wall portion and a second wall portion opposite to the first wall portion, the first wall portion has a first depression formed therein extending towards the second wall portion, the first depression comprises a first opening, a first bottom wall and a first peripheral side wall connecting the first bottom wall to a first flange of the first opening, the first bottom wall is coupled in a leak tight manner to the second wall portion in a coupling area having a hole through which passes a connecting rod of a clamping device, the clamping device comprises a first clamping portion and a second clamping portion connected to the first clamping portion by the connecting rod, wherein the first clamping portion is disposed on an outer face of the first peripheral side wall and the second clamping portion is disposed on an outer face of the second wall portion.

Thanks to this arrangement, when the internal pressure in the storage tank increases, the forces which tend to separate the first wall portion from the second wall portion in the coupling area are taken up by the first peripheral side wall and the second wall portion, thus avoiding the introduction of mechanical stresses in the coupling area. Indeed, the first clamping portion cooperates with the second clamping portion for applying a clamping force between the first peripheral side wall and the second wall portion when the internal pressure in the storage tank increases. The clamping force opposes the forces which tend to separate the first wall portion from the second wall portion in the coupling area with substantially equal and opposed forces. Compared to the approach in the prior art where the kiss point is reinforced, since the coupling area is not subjected to mechanical stresses, the coupling area does not need to be reinforced. Therefore, the size of the coupling area may be as small as possible without causing cracks or other damages in the coupling area over time. Herein, the coupling area is related to a kiss point.

By the expression “a wall delimiting a storage volume for containing a liquid and gas” is meant a wall forming a hollow body for liquid and gas contenting. The wall has an inner face and an outer face, the inner face is the face coming into contact with the liquid and gas and the outer face is the face not in contact with the liquid and gaz.

By the expression “the wall portion has a depression formed therein” is meant that the wall portion has a depressed cavity formed therein. A depressed cavity is defined by an opening to a blind hole.

By the expression “a flange of the opening” is meant a contour portion of the wall portion that surrounds the opening of the depression.

By the expression “the bottom wall is coupled in a leak tight manner to the wall portion” is meant that a leak tight coupling is provided between the bottom wall and the wall portion. The leak tight coupling may be obtained by welding together the bottom wall and the wall portion creating a welding interface in the coupling area. Alternatively, the leak tight coupling may be obtained by disposing a seal element between the bottom wall and the wall portion. The seal element is defined by an element providing a tight contact between the bottom wall and the wall portion in the coupling area. Said tight contact avoids the leak of liquid and gas to outside of the storage tank.

By the expression “the clamping portion is disposed on an outer face of the peripheral side wall” is meant that a contact surface of the clamping portion is applied to an outer face of the peripheral side wall in such a way that the clamping portion is removably attached to the peripheral side wall.

By the expression “the clamping portion is disposed on an outer face of the wall portion” is meant that a contact surface of the clamping portion is applied to an outer face of the wall portion in such a way that the clamping portion is removably attached to the wall portion.

In an embodiment, the clamping device is removable. As a result, the clamping device may be easily removed from the storage tank. This feature enables separate collection and recycling of the clamping device. Therefore, the recycling of the tank is improved.

In a preferred embodiment, the storage tank is a plastic fuel tank. The term “plastic” means any material comprising at least one synthetic resin polymer.

Any type of plastic may be suitable. Particularly suitable plastics belong to the category of thermoplastics. In particular, it is possible to use polyolefins, thermoplastic polyesters, polyketones, polyamides and copolymers thereof. A blend of polymers or copolymers may also be used, similarly it is also possible to use a blend of polymeric materials with inorganic, organic and/or natural fillers such as, for example, but not limited to, carbon, salts and other inorganic derivatives, natural or polymeric fibers. It is also possible to use multilayer structures composed of stacked and joined layers comprising at least one of the polymers or copolymers described above.

One polymer that is often used is polyethylene. Excellent results have been obtained with high-density polyethylene (HDPE). The wall of the tank may be composed of a single thermoplastic layer, or of two layers. One or more other possible additional layers may, advantageously, be composed of layers made of a barrier material to liquids and/or gases. Preferably, the nature and thickness of the barrier layer are chosen so as to minimize the permeability of liquids and gases in contact with the internal surface of the tank. Preferably, this layer is based on a barrier resin, that is to say a resin that is impermeable to the fuel such as, for example, EVOH (a partially hydrolyzed ethylene-vinyl acetate copolymer). Alternatively, the tank may be subjected to a surface treatment (fluorination or sulphonation) for the purpose of making it impermeable to the fuel. The tank according to the invention preferably comprises an EVOH-based barrier layer located between the HDPE-based outer layers.

In a preferred embodiment, the connecting rod is made of a rigid material having good tensile strength and impact strength. A particularly suitable rigid material is, for example, steel, plastic reinforced or not with fibers such as glass fibers and the like or Kevlar®.

In a preferred embodiment, the first clamping portion is disposed on an outer face of the first bottom wall. This arrangement allows the connecting rod to be shorter.

In a preferred embodiment, the first clamping portion is disposed on an outer face of the first flange of the first opening. This arrangement allows the forces which tend to separate the first wall portion from the second wall portion in the coupling area to be also taken up by the first flange of the first opening.

In a preferred embodiment, the first peripheral side wall comprises a first conical side wall and the first clamping portion comprises a first clamping conical side wall disposed on an outer face of the first conical side wall. This arrangement allows a conical fitting of the first clamping portion into the first peripheral side wall. Indeed, in the case where the first peripheral side wall does not comprise a first conical side wall but rather a first cylindrical side wall and the first clamping portion does not comprise a first clamping conical side wall but rather a first clamping cylindrical side wall, the contact surface between the first clamping portion and the first peripheral side wall is a cylindrical contact surface, which means that the clamping force is only a frictional clamping force, which is less interesting in terms of mechanical strength.

In a preferred embodiment, the second wall portion has a second depression formed therein extending towards the first depression, the second depression comprises a second opening, a second bottom wall and a second peripheral side wall connecting the second bottom wall to a second flange of the second opening, the second bottom wall is coupled in a leak tight manner to the first bottom wall in the coupling area having the hole through which passes the clamping device, and wherein the second clamping portion is disposed on an outer face of the second peripheral side wall. This arrangement allows the forces which tend to separate the first wall portion from the second wall portion in the coupling area to be taken up by the first peripheral side wall and the second peripheral side wall. Herein, the clamping force is applied between the first peripheral side wall and the second peripheral side wall.

By the expression “the second bottom wall is coupled in a leak tight manner to the first bottom wall” is meant that a leak tight coupling is provided between the second bottom wall and the first bottom wall. The leak tight coupling may be obtained by welding together the second bottom wall and the first bottom wall creating a welding interface in the coupling area. Alternatively, the leak tight coupling may be obtained by disposing a seal element between the second bottom wall and the first bottom wall. The seal element is defined by an clement providing a tight contact between the first bottom wall and the second bottom wall in the coupling area. Said tight contact avoids the leak of liquid and gas to outside of the storage tank.

In a preferred embodiment, the second clamping portion is disposed on an outer face of the second bottom wall. This arrangement allows the connecting rod to be shorter.

In a preferred embodiment, the second clamping portion is disposed on an outer face of the second flange of the second opening. This arrangement allows the forces which tend to separate the first wall portion from the second wall portion in the coupling area to be also taken up by the second flange of the second opening.

In a preferred embodiment, the second peripheral side wall comprises a second conical side wall and the second clamping portion comprises a second clamping conical side wall disposed on an outer face of the second conical side wall. This arrangement allows a conical fitting of the second clamping portion into the second peripheral side wall. Indeed, in the case where the second peripheral side wall does not comprise a second conical side wall but rather a second cylindrical side wall and the second clamping portion does not comprise a second clamping conical side wall but rather a second clamping cylindrical side wall, the contact surface between the second clamping portion and the second peripheral side wall is a cylindrical contact surface, which means that the clamping force is only a frictional clamping force, which is less interesting in terms of mechanical strength.

In a preferred embodiment, the first peripheral side wall comprises a first peripheral side wall portion and a second peripheral side wall portion connected to the first peripheral side wall portion by a first shoulder, the first clamping portion is disposed on an outer face of the first peripheral side wall portion and on an outer face of the second peripheral side wall portion. This arrangement allows to increase the contact surface between the first clamping portion and the first peripheral side wall and to reduce the mechanical stresses in the first peripheral side wall.

In a preferred embodiment, the first peripheral side wall portion, respectively the second peripheral side wall portion, comprises a third conical side wall, respectively a fourth conical side wall, and the first clamping portion comprises a third clamping conical side wall, respectively a fourth clamping conical side wall, disposed on an outer face of the third conical side wall, respectively on an outer face of the fourth conical side wall. This arrangement allows a conical fitting of the first clamping portion into the first peripheral side wall portion, respectively the second peripheral side wall portion, of the first peripheral side wall.

In a preferred embodiment, the first clamping portion is disposed on an outer face of the first shoulder. This arrangement allows the forces which tend to separate the first wall portion from the second wall portion in the coupling area to be also taken up by the first shoulder.

In a preferred embodiment, the second peripheral side wall comprises a third peripheral side wall portion and a fourth peripheral side wall portion connected to the third peripheral side wall portion by a second shoulder, the second clamping portion is disposed on an outer face of the third peripheral side wall portion and on an outer face of the fourth peripheral side wall portion. This arrangement allows to increase the contact surface between the second clamping portion and the second peripheral side wall and to reduce the mechanical stresses in the second peripheral side wall.

In a preferred embodiment, the third peripheral side wall portion, respectively the fourth peripheral side wall portion, comprises a fifth conical side wall, respectively a sixth conical side wall, and the second clamping portion comprises a fifth clamping conical side wall, respectively a sixth clamping conical side wall, disposed on an outer face of the fifth conical side wall, respectively on an outer face of the sixth conical side wall. This arrangement allows a conical fitting of the second clamping portion into the third peripheral side wall portion, respectively the fourth peripheral side wall portion, of the second peripheral side wall.

In a preferred embodiment, the second clamping portion is disposed on an outer face of the second shoulder. This arrangement allows the forces which tend to separate the first wall portion from the second wall portion in the coupling area to be also taken up by the second shoulder.

In a preferred embodiment, the connecting rod comprises a connection mechanism selected from the group consisting of bolt connection, screw-nut connection, rivet connection, frictional connection, form-fitting connection and snap connection. This arrangement allows the connecting rod to connect the first clamping portion to the second clamping portion in a simple and secure manner.

In a preferred embodiment, the connection mechanism is a snap connection. It offers a simple and cost-effective solution for connecting the connecting rod to the first and second clamping portions of the clamping device.

Preferably, the screw-nut connection includes a washer.

In a preferred embodiment, the clamping device supports at least one accessory or component of the vehicle, for example a valve or a pump such as a leak detection pump.

It is also provided according to the invention a vehicle comprising a storage tank as described above.

### BRIEF DESCRIPTION OF THE FIGURES

Other features and advantages would appear by reading the following description, given as an illustrative and non-restrictive example, and with the annexed drawings in which:

FIG. 1 is a cross section of a storage tank according to a first embodiment of the invention,

FIG. 2 is a cross section of a storage tank according to a second embodiment of the invention,

FIG. 3a is a view of the clamping device shown in FIG. 1,

FIG. 3b shows a variant of the clamping device shown in FIG. 3a ,

FIG. 4 is a cross section of a storage tank according to a third embodiment of the invention,

FIG. 5 is a cross section of a storage tank according to a fourth embodiment of the invention,

FIG. 6 is a cross section of a storage tank according to a fifth embodiment of the invention,

FIG. 7 is a cross section of a storage tank according to a sixth embodiment of the invention,

FIG. 8 is a view of the clamping device shown in FIG. 4,

FIG. 9 is a cross section of a storage tank according to a seventh embodiment of the invention,

FIG. 10 is a view of the clamping device shown in FIG. 9,

FIG. 11 is a general view of a vehicle according to the invention.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the components or elements may be exaggerated and not drawn on scale for illustrative purposes. The dimensions and the relative dimensions do not correspond to actual reductions to practice of the invention.

It is to be noticed that the terms “comprising” and ‘comprises” should not be interpreted as being restricted to the components, elements or steps listed thereafter; it does not exclude other components, elements or steps. It is thus to be interpreted as specifying the presence of the components, elements or steps as referred to, but does not preclude the presence or addition of one or more other components, elements or steps thereof. Thus, the scope of the expression “a device comprising means A and B” should not be limited to devices consisting only of elements A and B. It means that with respect to the present invention, the only relevant elements of the device are A and B.

In the description, it is possible to index certain elements, parameters or criteria, such as for example first element or second element as well as first parameter and second parameter, or first criterion and second criterion, and so on. In this case, it is a simple indexing to differentiate and name similar but not identical elements, parameters or criteria. This indexing does not imply a priority of one element, parameter or criterion with respect to another, and such denominations can easily be interchanged without departing from the context of the present description. This indexing does not imply either an order in time.

In the figures illustrating the present invention, the same reference signs denote the same components or elements. In addition, a feature described in conjunction with one embodiment is not necessarily limited to that embodiment and can be practiced in conjunction with any other embodiments of the invention.

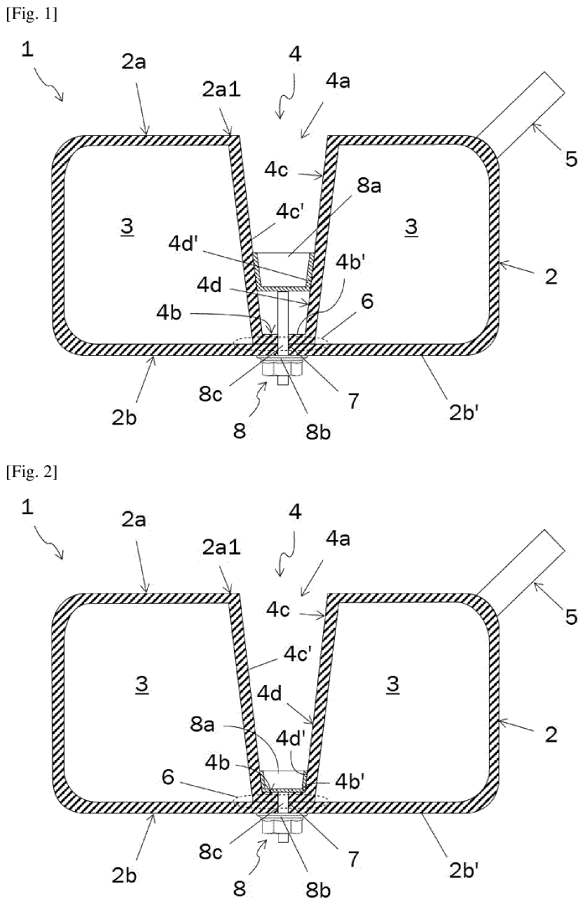

FIGS. 1 and 2 illustrate a storage tank 1 for a vehicle comprising a wall 2 delimiting a storage volume 3 for containing a liquid such as a fuel and gas such as a mixture of air and fuel vapor. A filling pipe 5 is provided for filling the storage tank 1 with the liquid. The wall 2 comprises a first wall portion 2a and a second wall portion 2b. The second wall portion 2b is opposite to the first wall portion 2a. The first wall portion 2a has a first depression 4 formed therein extending towards the second wall portion 2b. The first depression 4 comprises a first opening 4a, a first bottom wall 4b and a first peripheral side wall 4c. The first peripheral side wall 4c connects the first bottom wall 4b to a first flange 2a1 of the first opening 4a. The first bottom wall 4b is coupled in a leak tight manner to the second wall portion 2b in a coupling area 6. The coupling area 6 has a hole 7 through which passes a connecting rod 8c of a clamping device 8. The clamping device 8 comprises a first clamping portion 8a and a second clamping portion 8b. The second clamping portion 8b is connected to the first clamping portion 8a by the connecting rod 8c. The first clamping portion 8a is disposed on an outer face 4c′ of the first peripheral side wall 4c and the second clamping portion 8b is disposed on an outer face 2b′ of the second wall portion 2b. In the depicted examples, the storage tank 1 is obtained by blow molding of plastic material preform and the leak tight coupling is obtained by welding together the first bottom wall 4b and the second wall portion 2b creating a welding interface in the coupling area 6.

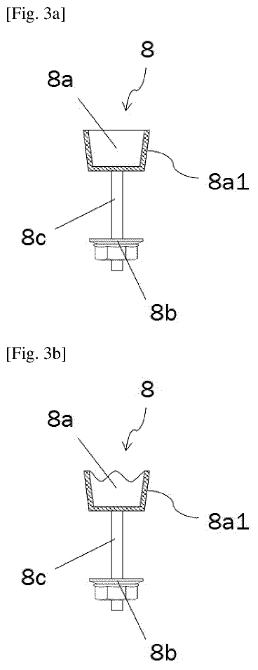

Advantageously, the first peripheral side wall 4c comprises a first conical side wall 4d and the first clamping portion 8a comprises a first clamping conical side wall 8a1 as illustrated in FIG. 3a. The first clamping conical side wall 8a1 is disposed on an outer face 4d′ of the first conical side wall 4d. In the depicted examples, the first clamping portion 8a has a cup-like shape with a bottom wall and a peripheral wall which is the first clamping conical side wall 8a1.

Advantageously, the first clamping conical side wall 8a1 has a crown-like shape as illustrated in FIG. 3b. This design improves mechanical stress distribution.

The embodiment shown in FIG. 2 differs from the embodiment shown in FIG. 1 in that the first clamping portion 8a is disposed on an outer face 4b′ of the first bottom wall 4b.

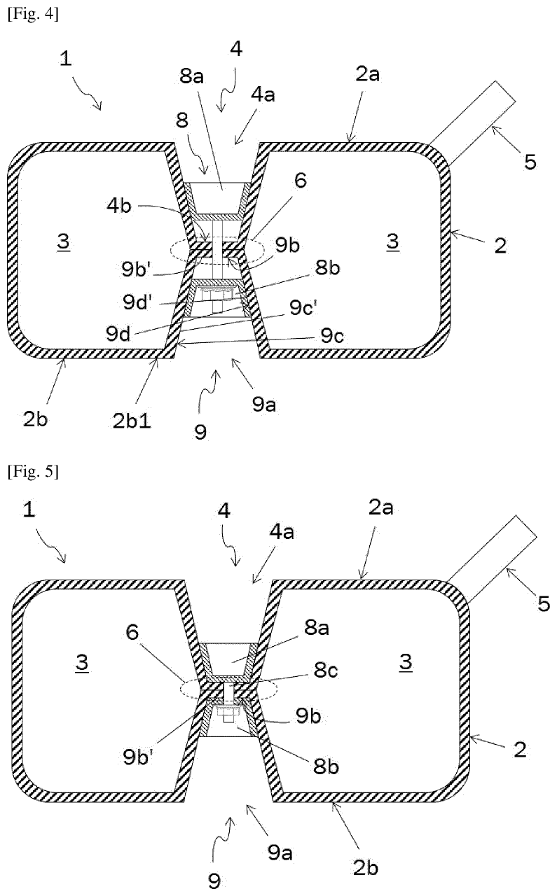

FIGS. 4, 5, and 6 illustrate other embodiments of the storage tank 1 in which the second wall portion 2b has a second depression 9 formed therein extending towards the first depression 4. The second depression 9 comprises a second opening 9a, a second bottom wall 9b and a second peripheral side wall 9c. The second peripheral side wall 9c connects the second bottom wall 9b to a second flange 2b1 of the second opening 9a. The second bottom wall 9b is coupled in a leak tight manner to the first bottom wall 4b in the coupling area 6 having the hole 7 through which passes the connecting rod 8c. The second clamping portion 8b is disposed on an outer face 9c′ of the second peripheral side wall 9c. In the depicted examples, the storage tank 1 is obtained by blow molding of plastic material preform and the leak tight coupling is obtained by welding together the first bottom wall 4b and the second bottom wall 9b creating a welding interface in the coupling area 6.

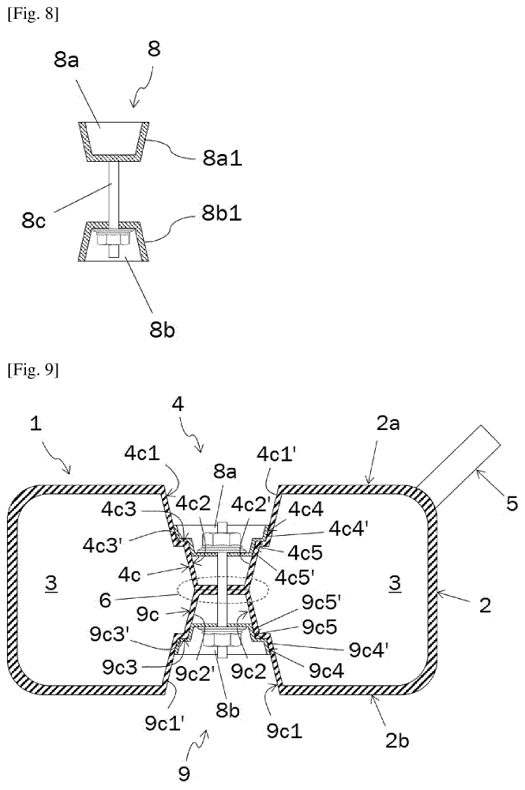

Advantageously, the second peripheral side wall 9c comprises a second conical side wall 9d and the second clamping portion 8b comprises a second clamping conical side wall 8b1 as illustrated in FIG. 8. The second clamping conical side wall 8b1 is disposed on an outer face 9d′ of the second conical side wall 9d. In the depicted examples, the first clamping portion 8a, respectively the second clamping portion 8b, has a cup-like shape with a bottom wall and a peripheral wall which is the first clamping conical side wall 8a1, respectively the second clamping conical side wall 8b1.

Advantageously, the first clamping conical side wall 8a1 and/or the second clamping conical side wall 8b1 has a crown-like shape as illustrated in FIG. 3b.

The embodiment shown in FIG. 5 differs from the embodiment shown in FIG. 4 in that the second clamping portion 8b is disposed on an outer face 9b′ of the second bottom wall 9b.

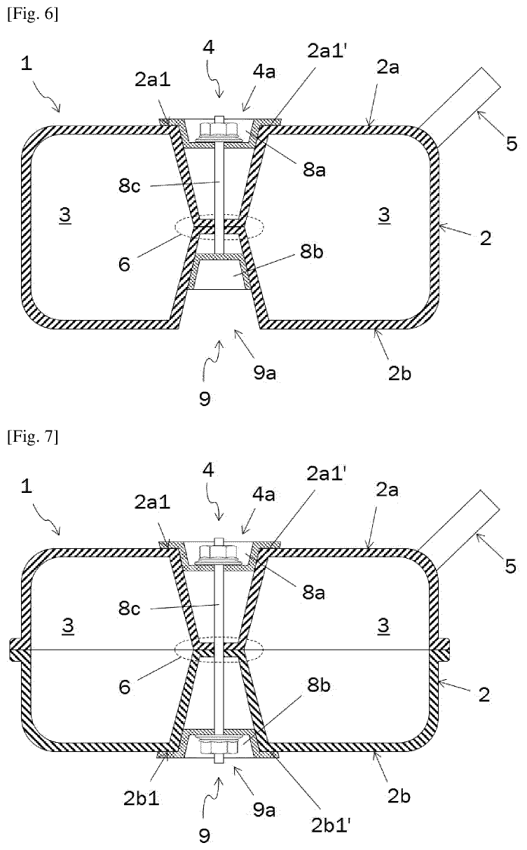

FIGS. 6 and 7 illustrate embodiments of the storage tank 1 in which the first clamping portion 8a is disposed on an outer face 2a1′ of the first flange 2a1 of the first opening 4a.

FIG. 7 illustrates an embodiment of the storage tank 1 in which the second clamping portion 8b is disposed on an outer face 2b1′ of the second flange 2b1 of the second opening 9a. In the depicted example, the storage tank 1 is not obtained by blow molding of plastic material preform but rather by injection molding of tank top and bottom shells.

FIG. 9 illustrates another embodiment of the storage tank 1 in which the first peripheral side wall 4c comprises a first peripheral side wall portion 4c1 and a second peripheral side wall portion 4c2. The second peripheral side wall portion 4c2 is connected to the first peripheral side wall portion 4c1 by a first shoulder 4c3. The first clamping portion 8a is disposed on an outer face 4c1′ of the first peripheral side wall portion 4c1 and on an outer face 4c2′ of the second peripheral side wall portion 4c2.

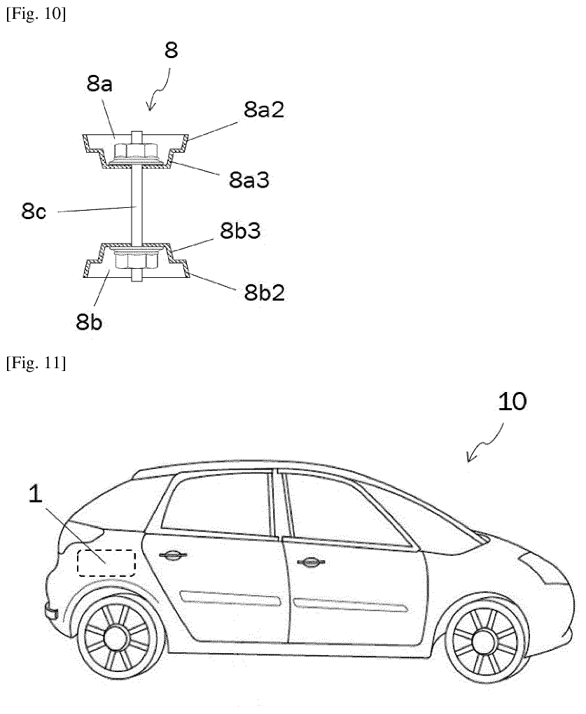

Advantageously, the first peripheral side wall portion 4c1 comprises a third conical side wall 4c4 and the first clamping portion 8a comprises a third clamping conical side wall 8a2 as illustrated in FIG. 10. The third clamping conical side wall 8a2 is disposed on an outer face 4c4′ of the third conical side wall 4c4. Similarly, the second peripheral side wall portion 4c2, comprises a fourth conical side wall 4c5, and the first clamping portion 8a comprises a fourth clamping conical side wall 8a3 as illustrated in FIG. 10. The fourth clamping conical side wall 8a3 is disposed on an outer face 4c5′ of the fourth conical side wall 4c5.

The first clamping portion 8a is disposed on an outer face 4c3′ of the first shoulder 4c3.

The second peripheral side wall 9c comprises a third peripheral side wall portion 9c1 and a fourth peripheral side wall portion 9c2 connected to the third peripheral side wall portion 9c1 by a second shoulder 9c3, the second clamping portion 8b is disposed on an outer face 9c1′ of the third peripheral side wall portion 9c1 and on an outer face 9c2′ of the fourth peripheral side wall portion 9c2.

Advantageously, the third peripheral side wall portion 9c1 comprises a fifth conical side wall 9c4 and the second clamping portion 8b comprises a fifth clamping conical side wall 8b2 as illustrated in FIG. 10. The fifth clamping conical side wall 8b2 is disposed on an outer face 9c4′ of the fifth conical side wall 9c4. Similarly, the fourth peripheral side wall portion 9c2, comprises a sixth conical side wall 9c5 and the second clamping portion 8b comprises a sixth clamping conical side wall 8b3 as illustrated in FIG. 10. The sixth clamping conical side wall 8b3 is disposed on an outer face 9c5′ of the sixth conical side wall 9c5.

The second clamping portion 8b is disposed on an outer face 9c3′ of the second shoulder 9c3.

The connecting rod 8c comprises a connection mechanism selected from the group consisting of bolt connection, screw-nut connection, rivet connection, frictional connection, form-fitting connection and snap connection. In a preferred embodiment, the connection mechanism is a screw-nut connection. The screw-nut connection includes a washer.

The clamping device supports at least one accessory or component of the vehicle, for example a valve or a pump such as a leak detection pump (not shown).

As illustrated in FIG. 11, the present invention also concerns a vehicle 10 comprising the storage tank 1.

The here-above embodiments are illustrative and not restrictive embodiments. Obviously, many modifications and variations of the present invention are possible in the light of the above teachings without deviating from its inventive concept. It has therefore to be understood that the invention may be practiced otherwise that as specifically described.

### LIST OF REFERENCES

1: storage tank
2: wall
2a: first wall portion
2a1: first flange
2a1′: outer face of the first flange
2b: second wall portion
2b′: outer face of the second wall portion
2b1: second flange
2b1′: outer face of the second flange
3: storage volume
4: first depression
4a: first opening
4b: first bottom wall
4b′: outer face of the first bottom wall
4c: first peripheral side wall
4c′: outer face of the first peripheral side wall
4c1: first peripheral side wall portion of the first peripheral side wall
4c1′: outer face of the first peripheral side wall portion
4c2: second peripheral side wall portion of the first peripheral side wall
4c2′: outer face of the second peripheral side wall portion
4c3: first shoulder
4c3′: outer face of the first shoulder
4c4: third conical side wall of the first peripheral side wall portion
4c4′: outer face of the third conical side wall
4c5: fourth conical side wall of the second peripheral side wall portion
4c5′: outer face of the fourth conical side wall
4d: first conical side wall of the first peripheral side wall
4d′: outer face of the first conical side wall
5: filling pipe
6: coupling area
7: hole
8: clamping device
8a: first clamping portion
8a1: first clamping conical side wall of the first clamping portion
8a2: third clamping conical side wall of the first clamping portion
8a3: fourth clamping conical side wall of the first clamping portion
8b: second clamping portion
8b1: second clamping conical side wall of the second clamping portion
8b2: fifth clamping conical side wall of the second clamping portion
8b3: sixth clamping conical side wall of the second clamping portion
8c: connecting rod
9: second depression
9a: second opening
9b: second bottom wall
9b′: outer face of the second bottom wall
9c: second peripheral side wall
9c′: outer face of the second peripheral side wall
9c1: third peripheral side wall portion of the second peripheral side wall
9c1′: outer face of the third peripheral side wall portion
9c2: fourth peripheral side wall portion of the second peripheral side wall
9c2′: outer face of the fourth peripheral side wall portion
9c3: second shoulder
9c3′: outer face of the second shoulder
9c4: fifth conical side wall of the third peripheral side wall portion
9c4′: outer face of the fifth conical side wall
9c5: sixth conical side wall of the fourth peripheral side wall portion
9c5′: outer face of the sixth conical side wall
9d: second conical side wall of the second peripheral side wall
9d′: outer face of the second conical side wall
10: vehicle

1. A storage tank for a vehicle comprising a wall delimiting a storage volume for containing a liquid and gas, the wall comprises a first wall portion and a second wall portion opposite to the first wall portion, the first wall portion has a first depression formed therein extending towards the second wall portion, the first depression comprises a first opening, a first bottom wall and a first peripheral side wall connecting the first bottom wall to a first flange of the first opening, the first bottom wall is coupled in a leak tight manner to the second wall portion in a coupling area having a hole through which passes a connecting rod of a clamping device, the clamping device comprises a first clamping portion and a second clamping portion connected to the first clamping portion by the connecting rod,
wherein the first clamping portion is disposed on an outer face of the first peripheral side wall and the second clamping portion is disposed on an outer face of the second wall portion.

2. A storage tank for a vehicle according to claim 1, wherein the first clamping portion is disposed on an outer face of the first bottom wall.

3. A storage tank for a vehicle according to any of the claim 1, wherein the first clamping portion is disposed on an outer face of the first flange of the first opening.

4. A storage tank for a vehicle according to any of the claim 1, wherein the first peripheral side wall comprises a first conical side wall and the first clamping portion comprises a first clamping conical side wall disposed on an outer face of the first conical side wall.

5. A storage tank for a vehicle according to claim 1, wherein the second wall portion has a second depression formed therein extending towards the first depression, the second depression comprises a second opening, a second bottom wall and a second peripheral side wall connecting the second bottom wall to a second flange of the second opening, the second bottom wall is coupled in a leak tight manner to the first bottom wall in the coupling area having the hole through which passes the connecting rod, and wherein the second clamping portion is disposed on an outer face of the second peripheral side wall.

6. A storage tank for a vehicle according to claim 5, wherein the second clamping portion is disposed on an outer face of the second bottom wall.

7. A storage tank for a vehicle according to any of claim 5, wherein the second clamping portion is disposed on an outer face of the second flange of the second opening.

8. A storage tank for a vehicle according to any of claim 5, wherein the second peripheral side wall comprises a second conical side wall and the second clamping portion comprises a second clamping conical side wall disposed on an outer face of the second conical side wall.

9. A storage tank for a vehicle according to claim 1, wherein the first peripheral side wall comprises a first peripheral side wall portion and a second peripheral side wall portion connected to the first peripheral side wall portion by a first shoulder, the first clamping portion is disposed on an outer face of the first peripheral side wall portion and on an outer face of the second peripheral side wall portion.

10. A storage tank for a vehicle according to claim 9, wherein the first peripheral side wall portion, respectively the second peripheral side wall portion, comprises a third conical side wall, respectively a fourth conical side wall, and the first clamping portion comprises a third clamping conical side wall, respectively a fourth clamping conical side wall, disposed on an outer face of the third conical side wall, respectively on an outer face of the fourth conical side wall.

11. A storage tank for a vehicle according to any of claim 9, wherein the first clamping portion is disposed on an outer face of the first shoulder.

12. A storage tank for a vehicle according to any of claim 9, wherein the second peripheral side wall comprises a third peripheral side wall portion and a fourth peripheral side wall portion connected to the third peripheral side wall portion by a second shoulder, the second clamping portion is disposed on an outer face of the third peripheral side wall portion and on an outer face of the fourth peripheral side wall portion.

13. A storage tank for a vehicle according to claim 12, wherein the third peripheral side wall portion, respectively the fourth peripheral side wall portion, comprises a fifth conical side wall, respectively a sixth conical side wall, and the second clamping portion comprises a fifth clamping conical side wall, respectively a sixth clamping conical side wall, disposed on an outer face of the fifth conical side wall, respectively on an outer face of the sixth conical side wall.

14. A storage tank for a vehicle according to any of claim 12, wherein the second clamping portion is disposed on an outer face of the second shoulder.

15. A storage tank for a vehicle according to claim 1, wherein the connecting rod comprises a connection mechanism selected from the group consisting of bolt connection, screw-nut connection, rivet connection, frictional connection, form-fitting connection and snap connection.

16. A vehicle comprising a storage tank according to claim 1.
